(19) United States
(12) Patent Application Publication
(10) Pub. No.: US 2012/0285616 A1
(43) Pub. Date: Nov. 15, 2012

(54) Environment-Friendly and Electrically Conductive Belt and Method of Preparing the Same

(76) Inventor: Chang Wook Choi, Yangsan-City (KR)

(21) Appl. No.: 13/556,823

(22) Filed: Jul. 24, 2012

Related U.S. Application Data
(63) Continuation of application No. PCT/KR2011/001877, filed on Mar. 18, 2011.

(30) Foreign Application Priority Data
Mar. 19, 2010 (KR) 10-2010-0024870

(51) Int. Cl. F16G 1/00; F16G 5/00; B32B 37/02; B65G 15/34; B32B 37/14; F16G 1/04; F16G 1/28

(52) U.S. Cl. 156/280; 474/266; 474/265; 474/238; 198/846; 156/60

(57) ABSTRACT

A belt includes a rubber core covered with a cover fabric including conductivity filaments oriented in warp and weft yarn directions. The method of preparing the belt comprises (i) preparing a cover fabric by orienting conductivity filaments in warp and weft yarn directions, and (ii) covering the cover fabric on a rubber core. The belt is environment-friendly because carbon black, which may produce environmentally hazardous substances, is excluded from the belt. The conductivity filaments are oriented in canvas of the belt with a predetermined interval, so that electrical conductivity can be represented on the entire surface of the belt.

### CROSS REFERENCE TO RELATED APPLICATIONS

This application is a continuation application of international patent application PCT/KR2011/001877, filed Mar. 18, 2011, designating the United States and claiming priority from Korean application 10-2010-0024870, filed Mar. 19, 2010, and the entire content of both applications is incorporated herein by reference.

### FIELD OF THE INVENTION

The present invention relates to an environment-friendly and electrically conductive belt and a method of preparing the same.

### BACKGROUND OF THE INVENTION

In general, an industrial rubber belt is made of carbon powder named carbon black to maintain the strength and the quality of rubber while providing electrical conductivity to the surface of the belt. Since such carbon black serves as a contributor for PAHs (polycyclic aromatic hydrocarbons), which is a kind of a toxic substance, the carbon black may not be an environment-friendly material.

FIG. 1 is a sectional view showing a portion of a conventional industrial wrapped V-belt. Such an industrial wrapped V-belt is fabricated by combining a variety of rubber, canvas and a tension member 30, which is composed of polyester, by taking the driving characteristic of the belt into consideration. Since various stresses (for example, flexion deformity) repeatedly and continuously occur due to the driving characteristic of the belt, rubber used for the belt requires appropriate strength and strain against the stresses. In order to provide such strength and strain to the belt, carbon powder such as carbon black as well as raw rubber are added and in order to bond polymer chains of raw rubber with each other, sulfur (S), a vulcanization accelerator, an antioxidant, and other chemicals are added to the raw rubber.

In addition, the rubber belt includes a variety of rubber 10, 20, 40, and 50 (see FIG. 1) due to the characteristics thereof. Accordingly, several toxic substances may be derived from chemicals used for fabricating the rubber. For instance, there may be PAHs derived from carbon black, nitrosamine derived from a thiuram-based vulcanization accelerator, and aromatic toxic substances derived from process oil. If such a harmful rubber belt is mounted on a machine related to beverages and foods, serious problems may occur. Even if a very small amount of a toxic substance is contained in the rubber belt, the toxic substance directly or indirectly exerts a harmful influence on a human body through fine dust that may be generated when the rubber belt is driven. Accordingly, it is very important to completely remove a toxic factor.

However, if carbon black, thiuram-based accelerators, and process oil are excluded in order to fabricate an environment-friendly belt, electrical conductivity essential for an industrial belt may be lost. In the case of a conventional wrapped V-belt, rubber is coated on canvas wrapping an outer portion of the V-belt through a surface treatment process, so that the V-belt obtains electrical conductivity by carbon black contained in the rubber. If rubber having no carbon black is surface-treated, the V-belt may lose the electrical conductivity. The rubber containing carbon represents electrical conductivity because a great amount of π electrons are distributed in carbon.

In general, since a belt having no electrical conductivity generates static electricity due to driving friction or ambient environment, if the belt is used in a specific place in which oil leaks or dust is generated, explosion or fire may occur due to the static electricity.

### SUMMARY OF THE INVENTION

Accordingly, the present invention has been made to solve the above-mentioned problems occurring in the prior art, and the present invention provides an environment-friendly and electrically conductive belt and a method of preparing the same, in which materials, which may produce environmentally hazardous substances, are excluded from a mixture for a rubber belt, and electrically conductive fibers are uniformly oriented in warp and weft yarn directions in canvas applied to a conventional belt product, so that the electrical conductivity can be represented on the surface of the rubber belt.

An object of the present invention is to provide an environment-friendly and electrically conductive belt without materials such as carbon black that may produce environmentally hazardous substances.

Another object of the present invention is to provide a method of preparing the environment-friendly and electrically conductive belt.

In accordance with an aspect of the present invention, there is provided a belt including a rubber core covered with a cover fabric 60 including conductivity filaments 70 oriented in warp and weft yarn directions.

An interval between the conductivity filaments 70 is preferably a range of 0.1 cm to 3 cm, but the present invention is not limited thereto.

The rubber core may further include a tension member 30.

The belt may further include a friction rubber layer provided at one side surface of the cover fabric 60.

The tension member 30 may include at least one selected from the group consisting of polyester, aramid, nylon, and glass fiber, but the present invention is not limited thereto.

The rubber core may include at least one selected from the group consisting of natural rubber, butadiene rubber, styrene butadiene rubber, chloroprene rubber, and ethylene propylene rubber, but the present invention is not limited thereto.

The rubber core may include at least one selected from the group consisting of compression rubber 10, cushion rubber 20, tension rubber 40, and friction rubber 50.

The cover fabric 60 may include a cotton fabric, a blend fabric of cotton and polyester, or a blend fabric of cotton and nylon.

The cover fabric 60 has a thickness of 0.3 mm to 1.0 mm, but the present invention is not limited thereto.

The conductivity filament 70 includes a stainless steel yarn or a carbon fiber, but the present invention is not limited thereto.

In one embodiment of the invention, the conductivity filament 70 may include a stainless steel yarn.

The conductivity filament 70 may include a mono-filament or a multi-filament.

In one embodiment of the invention, the belt may have a V-shape.

In one embodiment of the invention, the belt may further include a saw tooth (the toothed belt).

In one embodiment of the invention, the belt may be used for power transmission or a conveyer.

In one embodiment of the invention, the belt may have a sectional structure in a shape of an inverse trapezoid.

In accordance with another aspect of the present invention, there is provided a method of preparing an electrically conductive belt. The method includes (i) preparing a cover fabric by orienting conductivity filaments 70 in warp and weft yarn directions, and (ii) covering the cover fabric 60 on a rubber core.

An interval between the conductivity filaments 70 is preferably a range of 0.1 cm to 3 cm, but the present invention is not limited thereto.

### Advantageous Effects of Invention

As described above, the belt according to the present invention has no material such as carbon black that may produce environmentally hazardous substances, so that the belt is environment-friendly. In addition, electrically conductive fibers are oriented in canvas of the belt with a constant interval, so that electrical conductivity can be represented on the entire surface of the belt.

### BRIEF DESCRIPTION OF THE DRAWINGS

FIG. 1 is a sectional view showing a portion of a conventional industrial belt; and,

FIG. 2 is a sectional view showing a portion of an environment-friendly and electrically conductive belt according to a preferred embodiment of the present invention.

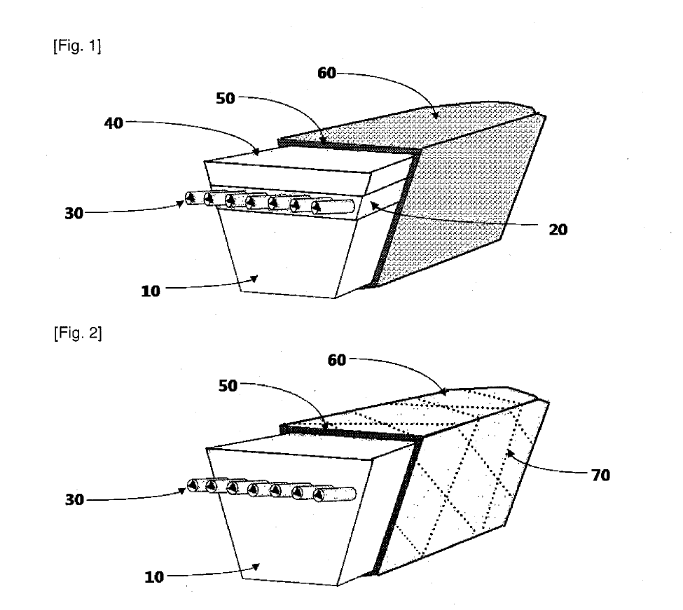

### DESCRIPTION OF THE PREFERRED EMBODIMENTS OF THE INVENTION

Hereinafter, a preferred embodiment of the present invention will be described in more detail. The following embodiments are for an illustrative purpose, but the scope of the present invention is not limited thereto.

### EMBODIMENTS

### Embodiment 1

### Preparation of Environment-Friendly and Electrically Conductive Belt

According to the present invention, materials that may produce environmentally hazardous substances are excluded from a mixture for a rubber belt, and conductive filaments are uniformly oriented in a canvas in weft and warp yarn directions so that the rubber belt can obtain electrical conductivity.

In detail, the electrically conductive belt according to the present invention can be prepared through the following steps.

1-1. Preparation of Conductive Cover Fabric

Stainless steel yarn is oriented in the canvas for a belt with an interval of 1.0 cm in warp and weft yarn directions, thereby preparing a cover fabric 60. Thereafter, after coating an inner side of the cover fabric 60 with thin friction rubber, the cover fabric 60 is slit by a desirable width according to standard requirements (Bias and Slitting step). Conductivity results according to intervals between conductivity filaments 70 are shown in Table 1.

TABLE 1

| Conductivity | Width of test | Voltage | Result |
|---|---|---|---|
| filament interval | sample of canvas | (V) | resistance (M) |
| 2 cm | 36 mm | 500 | 24.4 × 10³ |
| 1 cm | 36 mm | 500 | 0.20 |

1-2. Forming of Belt

Compression rubber 10 is cut by a predetermined length and is wound around a cylindrical drum of a forming machine. Thereafter, tension members 30 are wound above the compression rubber 10 with tensile force of 2.5 Kgf and 76 strands per 100 mm, and tension rubber 40 is wound above the tension members 30. After cutting a rubber core formed as described above into a predetermined width, the rubber core is formed in a V-shape (Skiving step). The rubber core is covered with the cover fabric 60 prepared in the previous step, thereby preparing the belt (Covering step).

1-3. Vulcanization of Belt

Although the belt that has covered with the cover fabric 60 in the previous step may be vulcanized by a Pot vulcanizer, a Roto vulcanizer, or a Press vulcanizer, according to the present invention, the belt is vulcanized by the Pot vulcanizer for 19 minutes by using a vapor pressure under the condition of an external pressure of 7.5 Kgf and an internal pressure of 4.5 Kgf. Accordingly, the belt obtains elasticity and strength.

Carbon black is not used for rubber employed when preparing the belt according to the present invention. In addition, thiuram-based accelerator and process oil are excluded from the rubber.

### Embodiment 2

### Electrical Conductivity of Belt of Present Invention

A conductivity experiment for the environmentally-friendly belt according to the present invention is performed, and the environmentally-friendly belt according to the present invention is compared with a conventional industrial belt in terms of electrical conductivity (see Table 2).

When measuring resistance of the V-belt after 24 hours from vulcanization by using a 500V-DC insulation resistance meter at a temperature of 15° C. to 30° C., the V-belt must satisfy Specification_IS01813 (ISO 1813 Belt drives-V-ribbed belts, joined V-belts and V-belts including wide section belts and hexagonal belts-Electrical conductivity of antistatic belts: Characteristics and methods of test) of Table 2.

TABLE 2

| | | | Belt of the |
|---|---|---|---|
| | | Conventional | present |
| | ISO1813 | Belt | invention |
| Resistance (M) | Max. 3.6 | 0.56 | 0.20 |

In Table 2, the conventional belt for the comparison test is fabricated by Roulunds Rubber Korea Ltd., satisfied SPZ specification, and currently sold in a belt market. The conventional belt is a general belt including carbon black.

As shown in Table 2, the belt according to the present invention is remarkably improved in electrical conductivity when comparing with the conventional belt.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A belt comprising a rubber core, wherein the rubber core is covered with a cover fabric including conductivity filaments oriented in warp and weft yarn directions.

2. The belt of claim 1, wherein an interval between the conductivity filaments is within a range of from 0.1 cm to 3 cm.

3. The belt of claim 1, wherein the rubber core further comprises a tension member.

4. The belt of claim 1, further comprising a friction rubber layer provided at one side surface of the cover fabric.

5. The belt of claim 3, wherein the tension member includes at least one member selected from the group consisting of polyester, aramid, nylon, and glass fiber.

6. The belt of claim 1, wherein the rubber core includes at least one member selected from the group consisting of natural rubber, butadiene rubber, styrene butadiene rubber, chloroprene rubber, and ethylene propylene rubber.

7. The belt of claim 1, wherein the rubber core includes at least one member selected from the group consisting of compression rubber, cushion rubber, tension rubber, and friction rubber.

8. The belt of claim 1, wherein the cover fabric includes a cotton fabric, a blend fabric of cotton and polyester, or a blend fabric of cotton and nylon.

9. The belt of claim 8, wherein the cover fabric has a thickness of from 0.3 mm to 1.0 mm.

10. The belt of claim 1, wherein each conductivity filament comprises a stainless steel yarn or a carbon fiber.

11. The belt of claim 10, wherein the conductivity filament comprises a stainless steel yarn.

12. The belt of claim 1, wherein the conductivity filament comprises a mono-filament or a multi-filament.

13. The belt of claim 1, wherein the belt has a V-shape.

14. The belt of claim 1, further comprising a saw tooth.

15. The belt of claim 1, wherein the belt is used for power transmission or a conveyer.

16. The belt of claim 1, wherein the belt has a sectional structure in a shape of an inverse trapezoid.

17. A method of preparing an electrically conductive belt, comprising:
(i) preparing a cover fabric by orienting conductivity filaments in warp and weft yarn directions; and
(ii) covering the cover fabric on a rubber core.

18. The method of claim 17, wherein an interval between the conductivity filaments is within a range of from 0.1 cm to 3 cm.

19. The method of claim 17, wherein the rubber core further comprises a tension member.

20. The method of claim 17, further comprising:
coating a friction rubber layer on one side surface of the cover fabric.

21. The method of claim 19, wherein the tension member comprises at least one member selected from the group consisting of polyester, aramid, nylon, and glass fiber.

22. The method of claim 17, wherein the rubber core comprises at least one member selected from the group consisting of natural rubber, butadiene rubber, styrene butadiene rubber, chloroprene rubber, and ethylene propylene rubber.

23. The method of claim 17, wherein the rubber core comprises at least one member selected from the group consisting of compression rubber, cushion rubber, tension rubber, and friction rubber.

24. The method of claim 17, wherein the cover fabric comprises a cotton fabric, a blend fabric of cotton and polyester, or a blend fabric of cotton and nylon.

25. The method of claim 24, wherein the cover fabric has a thickness of from 0.3 mm to 1.0 mm.

26. The method of claim 17, wherein each conductivity filament includes a stainless steel yarn or a carbon fiber.

27. The method of claim 26, wherein the conductivity filament includes a stainless steel yarn.

28. The method of claim 17, wherein the conductivity filament includes a mono-filament or a multi-filament.

29. The method of claim 17, wherein the belt has a V-shape.

30. The method of claim 17, wherein the belt further comprises a saw tooth.

31. The method of claim 17, wherein the belt has a sectional structure in a shape of an inverse trapezoid.
